(19) United States
(12) Patent Application Publication
(10) Pub. No.: US 2020/0273006 A1
(43) Pub. Date: Aug. 27, 2020

(54) INITIATING A FUNDS TRANSFER FROM A PLAYER'S MOBILE DEVICE TO A CASINO WALLET THAT REQUIRES HUMAN VALIDATION OF THE PLAYER'S IDENTITY

(71) Applicant: IGT, Las Vegas, NV (US)

(72) Inventors: Kevin Higgins, Reno, NV (US); Jeffery Shepherd, Reno, NV (US); Erik Petersen, Reno, NV (US)

(21) Appl. No.: 16/286,064

(22) Filed: Feb. 26, 2019

(51) Int. Cl. G06Q 20/10; G06Q 20/36

(52) U.S. Cl. CPC G06Q 20/105; G06Q 20/3674

(57) ABSTRACT

Embodiments include a mobile device comprising a wireless communications interface, a processor, and a memory. The memory can store instructions which causes the processor to receive an input indicating a request to initiate an update of a plurality of electronic records. The request to initiate the update of the plurality of electronic records can be sent through the first wireless communications interface to a gaming venue system and a message indicating authorization of the requested update of the plurality of electronic records pending verification of an identity of a user of the mobile device can be received from the gaming venue system through the first wireless communications interface. An indication of the authorization and an indication that the update of the plurality of electronic records is pending verification of the identity of the electronic device can then be presented through an output device of the mobile device.

### BACKGROUND

Embodiments of the present disclosure relate generally to electronics funds transfers and more particularly to updating electronic records associated with accounts of a user to conduct a transfer of funds initiated through a mobile device.

A person playing gambling games at a casino or other gaming venue can establish an account with the venue. Such an account can be used to place bets on the games, pay for drinks and/or food, etc. Once a player has established a wallet account, the account can be funded in various ways. For example, the player can transfer funds to the wallet account using an electronic check, which is sometimes called an Automated Clearing House (ACH) transfer. Other alternatives may be preferred by a player, such as using an Automated Teller Machine (ATM) card, or performing a credit card cash advance. However, some transfer methods, most notably a credit card cash advance, may require the player to present some form of identification, e.g., a driver's license, to a staff member of the casino before the transaction can be completed.

### BRIEF SUMMARY

In certain embodiments, the present disclosure relates to a mobile device comprising a first wireless communications interface, a processor coupled with the first wireless communications interface, and a memory coupled with and readable by the processor. The memory can store therein a set of instructions which, when executed by the processor, causes the processor to receive an input indicating a request to initiate an update of a plurality of electronic records. The request can comprise information defining the update of the plurality of electronic records. The request to initiate the update of the plurality of electronic records can be sent through the first wireless communications interface to a gaming venue system and a message indicating authorization of the requested update of the plurality of electronic records pending verification of an identity of a user of the mobile device can be received from the gaming venue system through the first wireless communications interface. An indication of the authorization and an indication that the update of the plurality of electronic records is pending verification of the identity of the electronic device can then be presented through an output device of the mobile device.

According to another embodiment, a system of a gaming venue can comprise a wireless communications interface, a processor coupled with the wireless communications interface, and a memory coupled with and readable by the processor. The memory can store therein a set of instructions which, when executed by the processor, causes the processor to receive, from a mobile device through the wireless communications interface, a request to initiate an update of a plurality of electronic records. The request can comprise information defining the update of the plurality of electronic records. At least a portion of the information defining the update of the plurality of electronic records can be sent to a system maintaining a first record of the plurality of electronic records and a message indicating that the update of the plurality of electronic records is authorized pending verification of an identity of a user of the mobile device can be received from the system maintaining the first record. A message indicating that the update of the plurality of electronic records is authorized pending verification of an identity of the user of the mobile device can be sent to the mobile device through the wireless communications interface.

According to yet another embodiment, a method for performing an update on a plurality of electronic records can comprise receiving, by a gaming venue system through a wireless communications interface, a request from a mobile device to update the plurality of electronic records. A determination can be made by the gaming venue system, that verification of an identity of a user of the mobile device is required to complete the update of the plurality of electronic records. In response to determining that verification of the identity of the user of the mobile device is required, the gaming venue system can send to the mobile device, through the wireless communications interface, a message indicating that verification of the identity of the user of the mobile device is required to complete the update of the plurality of electronic records and providing instructions for performing the verification of the identity of the user of the mobile device.

Additional features and advantages are described herein and will be apparent from the following Description and the figures.

BRIEF DESCRIPTION OF THE SEVERAL VIEWS OF THE DRAWINGS

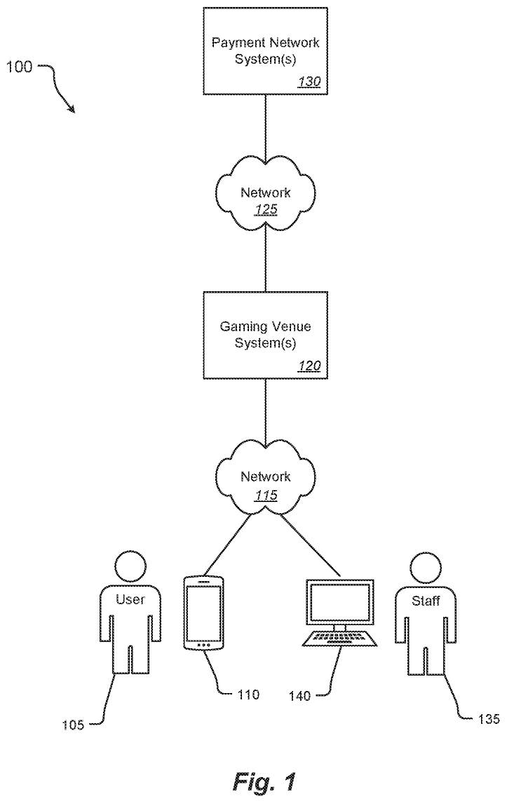

FIG. 1 is a block diagram illustrating an exemplary environment in which one or more embodiments of the present disclosure may be implemented.

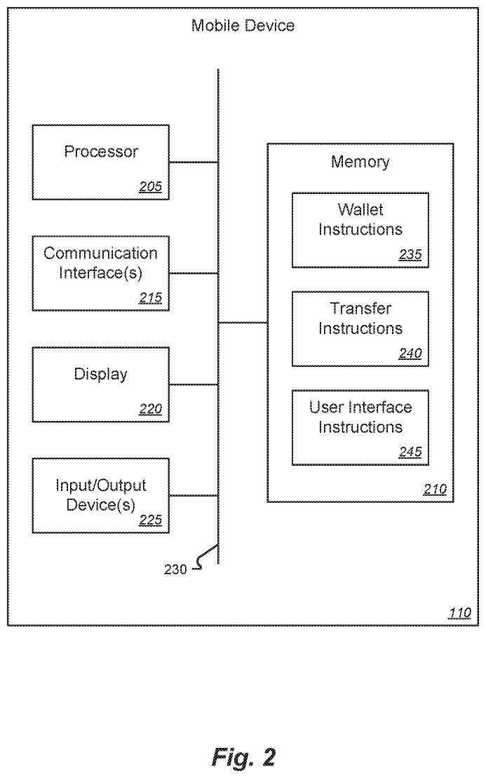

FIG. 2 is a block diagram illustrating additional details of an exemplary mobile device according to one embodiment of the present disclosure.

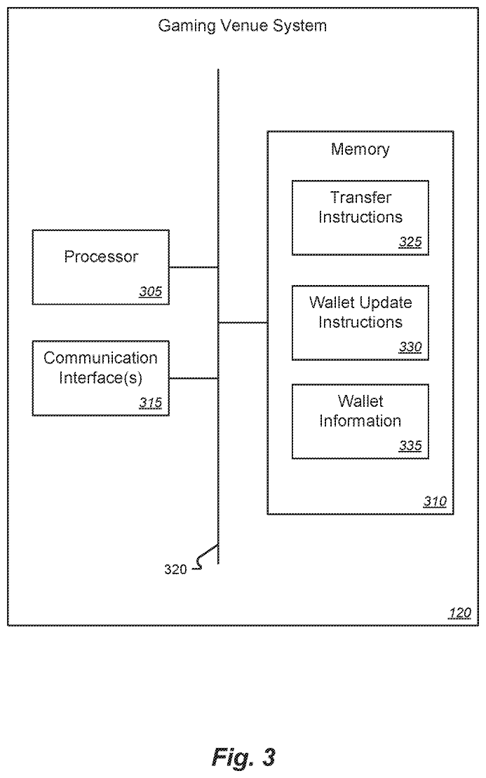

FIG. 3 is a block diagram illustrating additional details of an exemplary gaming venue system according to one embodiment of the present disclosure.

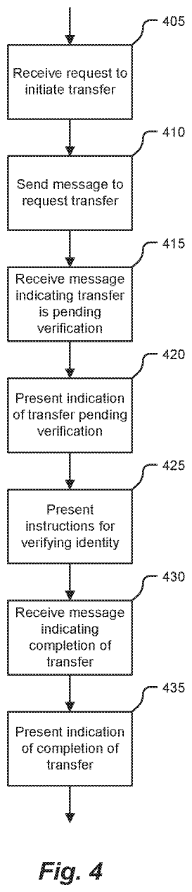

FIG. 4 is a flowchart illustrating an exemplary process for initiating a transaction according to one embodiment of the present disclosure.

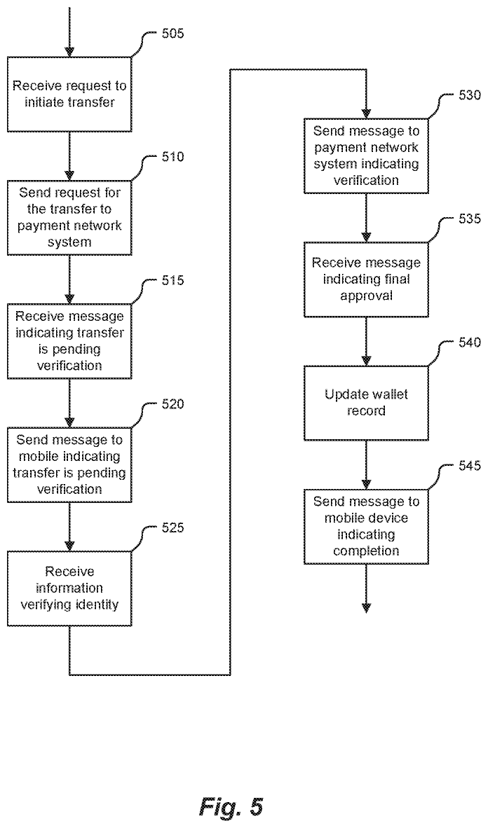

FIG. 5 is a flowchart illustrating an exemplary process for facilitating a transaction according to another embodiment of the present disclosure.

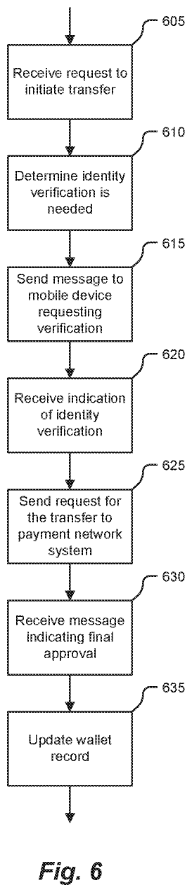

FIG. 6 is a flowchart illustrating an exemplary process for performing an update of records related to a transaction according to yet another embodiment of the present disclosure.

### DETAILED DESCRIPTION

Embodiments of the present disclosure include updating electronic records associated with accounts of a user to conduct a transfer of funds initiated through a mobile device. For example, the transfer of funds can comprise funding an electronic wallet of a user of the mobile device. Such an electronic wallet may be used in a casino or other gaming venue to place bets on game and/or pay for services such as ordering food or drinks. The transfer of funds initiated through the user's mobile device can comprise, for example, a transfer funds from another account of the user to the electronic wallet. For example, the transfer can comprise an Automated Clearing House (ACH) transfer. However, a downside of an ACH transfer is that it takes some time, two to three days on average, to complete. Other alternatives may be preferred by a player, such as using an Automated Teller Machine (ATM) card, or performing a credit card cash advance. Such transfers have the advantage that they can complete quickly, thereby allowing the player to access the newly transferred funds in the wallet account. However, some transfer methods, most notably a credit card cash advance, may require the player to present some form of identification, e.g., a driver's license, to a staff member of the casino before the transaction can be completed. In some cases, such as a credit card cash advance, the transfer may be placed into a pending state until an identity of the user of the mobile device can be verified. Accordingly, embodiments can include providing a notification to the user, through the mobile device that the transfer is pending such verification. In some cases, the notification can also include instructions for how to perform the verification.

FIG. 1 is a block diagram illustrating an exemplary environment in which one or more embodiments of the present disclosure may be implemented. As illustrated in this example, a system 100 can include a user 105 with a mobile device 110. The mobile device 110 may access a communications network 115, such as a wireless network within a casino or other gaming venue the user 105 is visiting. Also connected with the communications network 115 can be a gaming venue system 120. The gaming venue system can maintain, or have access to, one or more electronic records such as records associated with an electronic wallet account of the user 105 that has been established with the casino or gaming venue. As noted, such a wallet account can be used by the user 105 to place bets on games within the casino or gaming venue, pay for food, drinks, or other services, etc.

According to one embedment, and as will be described in greater detail below, the user 105 may initiate a transaction through the mobile device 110 to fund the electronic wallet, i.e., update an electronic record associated with his account based on a transfer of funds from another account into the electronic wallet. However, certain types of funds transfers may require a verification of the user's identity based on presentation of some identification credential, e.g., a driver's license, etc. before the transfer can complete. One example of this is a cash advance on a credit card account.

According to one embodiment, the user 105 can initiate such a transfer by logging into the mobile device 110 and opening an application which can fund the electronic wallet. The user can then select how much to transfer and the funding source. In other cases, the mobile application may suggest the source based on pre-defined configuration information etc. The application on the mobile device 110 can then communicate with the gaming venue system 120 to initiate the transfer transaction by making a request to a banking network or payment network system 130 though another communications network 125.

The payment network system 130 may then return a message indicating that the identity of the user making the request must be verified, e.g., by the user 105 presenting an identity credential such as a driver's license, before the requested transfer transaction can be completed. In an alternative embodiment, the gaming venue system can determine before submitting the transaction to the payment network system 130 that the user's identity must be verified before the requested transfer transaction can be completed. This determination can be based on the type of transaction, the type of account used to fund the transaction, etc. In either case, the gaming venue system 120 can send a message to the mobile device 110 to inform the user 105 that identity verification is required. In some cases, this message may also provide instructions to the user 105 describing how that verification can be performed. For example, the instructions can direct the user 105 to a particular location in the casino or gaming venue wherein the user can present an identity credential to a staff person for verification. In another embodiment, instead of instructing the user 105 to go to a particular location, a staff member 135, using a mobile terminal 140 such as a mobile phone, tablet, etc., can go to the user's location.

The user 105 can then go to the indicated location, or wait for the staff person 135, to verify his identity to the casino or gaming venue staff person 135. The user 105 can do this using one of many different approaches, including, but not limited to presenting a player's club card, tapping the mobile device 110 to a wireless terminal at the location thereby transferring previously stored identity credentials, e.g., a certificate etc., to the gaming venue system 120 via a reader supporting a wireless interface, such as, but not limited to, NFC reader, BLE reader, Wifi Reader, etc.

Additionally, or alternatively, the user 105 can present an identity credential, e.g., a driver's license, to the casino or gaming venue staff person 135 so that the user's identity can be verified. For example, the user 105 can present a driver's license to the casino or gaming venue staff member 135, who then verifies the user's 105 identity and submits to the gaming venue system 120 an indication of the verification through a terminal 140 at the location and connected to the gaming venue system 120 through the network 115. In another example, the casino or gaming venue staff person 135 can use the terminal 140 to look up the user's identity credential, e.g., a scan of the user's driver's license, that is on file with and saved by the gaming venue system 120 and compare that to the user 105 at the staff person's 135 location. Once the user's identity has been verified, then the staff person 135 can mark the user as verified through the terminal 140 to approve the financial transaction. Once the transaction is approved, it can be completed by the gaming venue system 120 notifying the payment network system 130 and the funds can be deposited into the user's electronic wallet.

FIG. 2 is a block diagram illustrating additional details of an exemplary mobile device according to one embodiment of the present disclosure. As illustrated in this example, a mobile device 110 can comprise a processor 205. The processor 205 may correspond to one or many computer processing devices. For instance, the processor 205 may be provided as silicon, as a Field Programmable Gate Array (FPGA), an Application-Specific Integrated Circuit (ASIC), any other type of Integrated Circuit (IC) chip, a collection of IC chips, or the like. As a more specific example, the processor 205 may be provided as a microprocessor, Central Processing Unit (CPU), or plurality of microprocessors that are configured to execute the instructions sets stored in a memory 210. Upon executing the instruction sets stored in memory 210, the processor 205 enables various functions of the mobile device 110 as described herein.

The memory 210 can be coupled with and readable by the processor 205 via a communications bus 230. The memory 210 may include any type of computer memory device or collection of computer memory devices. Non-limiting examples of memory 210 include Random Access Memory (RAM), Read Only Memory (ROM), flash memory, Electronically-Erasable Programmable ROM (EEPROM), Dynamic RAM (DRAM), etc. The memory 210 may be configured to store the instruction sets depicted in addition to temporarily storing data for the processor 205 to execute various types of routines or functions.

The processor 205 can also be coupled with one or more communication interfaces 215, a display 220, and one or more input/output devices 225 via the communications bus 230. The communication interfaces 215 can comprise, for example, a Bluetooth, WiFi, cellular, and/or other type of wireless communications interface. The display 220 can comprise, for example, a Liquid Crystal Display (LCD), Light Emitting Diode (LED), Organic Light Emitting Diode (OLED), display or other type of display for presenting video images and can be touch sensitive allowing the user to use the display 220 as an input device as well. The input/output devices 225 can include, but are not limited to, one or more of a speaker, a numeric and/or alphanumeric keypad, a touch pad, one or more buttons or switches, etc.

The memory 210 can store therein sets of instructions which, when executed by the processor 205, cause the processor 205 to initiate a transaction as described herein. For example, the memory 210 can store a set of wallet instructions 235 which, when executed by the processor 205, can cause the processor to access and maintain records related to a wallet account for the user 105 of the mobile device 110. A set of transfer instructions 240 can cause the processor 205 to initiate, and together with the wallet instructions 235, conduct a transfer of funds to the wallet account of the user 105 as will be described in greater detail below. The memory 210 can also store a set of user interface instructions 245 which, when executed by the processor 205, can cause the processor to generate a graphical and/or textual user interface and present the user interface to the user 105 through the display 220 thereby allowing the user 105 to interact with the functions performed by the processor 205 when executing the wallet instructions 235 and transfer instructions 240.

More specifically, the transfer instructions 240 can cause the processor 205 to receive an input indicating a request to initiate an update of a plurality of electronic records. For example, this input can be received in response to the user 105 of the mobile device 110 clicking or otherwise selecting a button, link, icon, or other user interface element presented on the display 220 by the processor 205 when executing the user interface instructions 245. The request can comprise information defining an update of a plurality of electronic records which may also be selected, input, or otherwise indicated by the user 105 through the user interface of the mobile device 110. For example, the information defining the update of the plurality of electronic records can comprise information identifying an amount of a transfer of funds from a first account of the user 105 of the mobile device 110 associated with a first record of the plurality of electronic records, e.g., a record associated with a bank account, credit card account, etc., to a second account of the user 105 of the mobile device 110 associated with a second record of the plurality of electronic records, e.g., a record associated with the mobile wallet account of the user 105 of the mobile device 110.

The transfer instructions 240 can then cause the processor 205 to send the request to initiate the update through the communications interface(s) 215 to a gaming venue system 120, e.g., a server or other computing system of a casino in which the user 105 of the mobile device 110 is gambling or paying for other services, and receive, from the gaming venue system 120 through the communications interface(s) 215, a message indicating authorization of the requested update of the plurality of electronic records pending verification of an identity of a user 105 of the mobile device 110. The transfer instructions 240 and user interface instructions 245 can then cause the processor 205 to present through the display 220 an indication of the authorization and an indication that the update of the plurality of electronic records is pending verification of the identity of the user, e.g., as a message displayed on the user interface, as an audio message played out through a speaker of the mobile device 110, etc. In some cases, this indication can also present instructions for how to perform the verification, e.g., by going to an identified location and presenting a form of identification to a staff person 135, by using the mobile device 110 to perform some or all of the verification process, etc.

Once the identity of the user 105 of the mobile device 110 has been verified, the transfer instructions 240 can cause the processor to receive, from the gaming venue system 120 through the communications interface(s) 215, a message indicating completion of the update of the plurality of electronic records, i.e., completion of the transfer and availability of the funds. The transfer instructions 240 and user interface instructions 245 can then cause the processor 205 to present an indication of the completion of the update of the plurality of electronic records through the display 220 of the mobile device 110. For example, a message can be displayed in the user interface or played out through a speaker of the mobile device 110 to inform the user 105 that the transfer has been successfully completed and that the funds are now available through the mobile wallet.

FIG. 3 is a block diagram illustrating additional details of an exemplary gaming venue system according to one embodiment of the present disclosure. As illustrated in this example, the gaming venue system 120 can comprise a processor 305 such as any of the various types of processors described above. A memory 310 can be coupled with and readable by the processor 305 via a communications bus 320. The memory 310 can comprises any one or more of the different types of volatile and/or non-volatile memories described above. The processor 305 can also be coupled with one or more communication interfaces 315 via the communications bus 320. The communication interfaces 315 can comprise, for example, a Bluetooth, WiFi, Ethernet and/or other type of wired and/or wireless communications interfaces.

The memory 310 can store therein sets of instructions which, when executed by the processor 305, cause the processor 305 to facilitate a transaction initiated through a mobile device 110 as described herein. More specifically, the memory 310 can store a set of transfer instructions 325 which, when executed by the processor 305, can cause the processor 305 to receive from the mobile device 110, through the communications interface(s) 315, a request to initiate an update of a plurality of electronic records. The request can comprise information defining the update of the plurality of electronic records. For example, the update of the plurality of electronic records can comprise a cash advance on a credit card account of the user 105 of the mobile device 110. In such cases, the information defining the update of the plurality of electronic records can comprise information identifying the credit card account and an amount of the cash advance, the first record of the plurality of electronic records can be associated with the credit card account, and the system maintaining the first record can comprise a payment network system 130. The transfer instructions 325 can cause the processor 305 to send, through the communications interface(s) 315, at least a portion of the information defining the update of the plurality of electronic records to the system maintaining the first record of the plurality of electronic records. The transfer instructions 325 can then cause the processor 305 to receive from the system maintaining the first record a message indicating that the update of the plurality of electronic records is authorized pending verification of an identity of a user 105 of the mobile device 110.

Alternatively, the transfer instructions 325 can cause the processor 305 to make a determination that verification of an identity of a user 105 of the mobile device 110 will be needed to complete the update of the plurality of electronic records before sending the information defining the update of the plurality of electronic records to the system maintaining the first record of the plurality of electronic records. Determining that verification of the identity of the user 105 of the mobile device 110 is required to complete the update of the plurality of electronic records can be based on a transaction type associated with the update of the plurality of electronic records, e.g., a credit card cash advance or transfer from another type of account for which the system maintaining that account is known to require such verification.

In either case, the transfer instructions 325 can then cause the processor 305 to send to the mobile device 110, through the communications interface(s), a message indicating that verification of an identity of the user 105 of the mobile device 110 is needed. According to one embodiment, the message can comprise instructions for providing verification of the identity of the user 105 of the mobile device 110. For example, the instructions for providing verification of the identity of the user 105 of the mobile device 110 can instruct the user 105 of the mobile device 110 to present an identity credential such as a driver's license at a location within the gaming venue. In another example, the instructions can instruct the user 105 of the mobile device 110 to present an identity credential to a mobile resource of the gaming venue, e.g., a staff person 135 with a mobile terminal 140, dispatched to a location of the user 105 of the mobile device 110. In such cases, providing the instructions can further comprise dispatching the mobile resource to the user's 105 location, e.g., sending an IM or other message to the staff person 135, through the mobile terminal 140 and indicating the location of the user 105 of the mobile device 110 which can be determined in any of a variety of ways as known in the art.

The transfer instructions 325 can then cause the processor 305 to receive information verifying the identity of the user 105 of the mobile device 110, e.g., a confirmation message from the terminal 140 of the staff person 135 doing the verification, send a message indicating or confirming verification of the identity of the user 105 of the mobile device 110 to the system maintaining the first record, e.g., the payment network system 130, and receive, in response, a message from the system maintaining the first record indicating a final approval of the update of the plurality of electronic records. In response, the transfer instructions 325 can cause the processor 305 to receive from the system maintaining the first record of the plurality of records, a message indicating authorization of the update of the plurality of records.

According to one embodiment, the memory 310 of the gaming venue system 120 can store a set of wallet update instructions 330. In some cases, the memory 310 may also store a set of wallet information 335. Based on the message indicating final approval of the update or transfer, the wallet update instructions 330 can cause the processor 305 to update a record associated with a gaming venue account of the user 105 of the mobile device 110 such as a mobile wallet account associated with a record in the wallet information 335. Updating this record can comprise increasing a value of the record representing an available game play credit amount based on the amount of the cash advance or other transfer of value. In other cases, such as where the memory 310 of the gaming venue system 120 does not maintain or have access to the wallet information 335 records, the wallet update instructions 330 can cause the processor 305 to send a request, through the communications interface(s) 315 to an appropriate system to perform the update to reflect the transfer. In either case, the transfer instructions 325 can then cause the processor to send to the mobile device 110, through the communications interface(s) 315, a message indicting completion of the cash advance or other transfer and availability of the game play credit amount.

FIG. 4 is a flowchart illustrating an exemplary process for initiating a transaction according to one embodiment of the present disclosure. More specifically, this example illustrates a process as may be performed by a mobile device 110 as described above in response to a user 105 of the mobile device 110 requesting a transfer, e.g., to fund his mobile wallet account from another account such as through a cash advance on a credit card account. As illustrated in this example, initiating a transaction can begin with receiving 405 an input indicating a request to initiate an update of a plurality of electronic records, For example, this input can be received in response to the user 105 of the mobile device 110 clicking or otherwise selecting a button, link, icon, or other user interface element presented on a display of the mobile device 110 and indicating a function to fund the mobile wallet account of the user 105. The request can comprise information defining the update of the plurality of electronic records which may also be selected, input, or otherwise indicated by the user 105 through the user interface of the mobile device 110. For example, the information defining the update of the plurality of electronic records can comprise information identifying an amount of a transfer of funds from a first account of the user 105 of the mobile device 110 associated with a first record of the plurality of electronic records, e.g., a record associated with a bank account, credit card account, etc., to a second account of the user 105 of the mobile device 110 associated with a second record of the plurality of electronic records, e.g., a record associated with the mobile wallet account of the user 105 of the mobile device 110. Additionally, or alternatively, the information defining the update of the plurality of electronic records can comprise information defining a payment instrument associated with the first account. For example, the payment instrument can comprise a credit card and the transfer of funds comprise a cash advance on the credit card.

The request to initiate the update of the plurality of electronic records can then be sent 410 from the mobile device 110, through the first wireless communications interface, to a gaming venue system 120, e.g., a casino in which the user 105 of the mobile device 110 is gambling or paying for other services. In response, the mobile device 110 can receive 415, from the gaming venue system 120 through the first wireless communications interface, a message indicating authorization of the requested update of the plurality of electronic records pending verification of an identity of a user 105 of the mobile device 110. An indication of the authorization and an indication that the update of the plurality of electronic records is pending verification of the identity of the user 105 of the mobile device 110 can then be presented 420, through an output device of the mobile device 110, e.g., as a message displayed on the user interface, as an audio message played out through a speaker of the mobile device 110, etc. In some cases, this indication can also present 425 instructions for how to perform the verification, e.g., by going to an identified location and presenting a form of identification to a staff person 135, by using the mobile device 110 to perform some or all of the verification process, etc. For example, the mobile device 110 can comprise a second wireless communications interface, such as BluTooth, NFC, of other similar interface and performing the verification can comprise using the mobile device 110 to provide, through the second wireless communications interface to the gaming venue system 120, information verifying the identity of the user 105 of the mobile device 110.

Once the identity of the user 105 of the mobile device 110 has been verified, the mobile device 110 can receive 430, from the gaming venue system 120 through the first wireless communications interface, a message indicating completion of the update of the plurality of electronic records. An indication of the completion of the update of the plurality of electronic records can be presented 435 through the output device of the mobile device 110. For example, a message can be displayed in the user interface or played out through a speaker of the mobile device 110 to inform the user 105 that the transfer has been successfully completed and that the funds are now available through the mobile wallet.

FIG. 5 is a flowchart illustrating an exemplary process for facilitating a transaction according to another embodiment of the present disclosure. More specifically, this example illustrates a process as may be performed by a gaming venue system 120 as described above in response to a user 105 of a mobile device 110 requesting a transfer, e.g., to fund his mobile wallet account from another account such as through a cash advance on a credit card account. As illustrated in this example, facilitating the requested transaction can begin with receiving 505 from the mobile device 110 through the wireless communications interface, a request to initiate an update of a plurality of electronic records. The request can comprise information defining the update of the plurality of electronic records. For example, the update of the plurality of electronic records can comprise a cash advance on a credit card account of the user 105 of the mobile device 110. In such cases, the information defining the update of the plurality of electronic records can comprises information identifying the credit card account and an amount of the cash advance, the first record of the plurality of electronic records can be associated with the credit card account, and the system maintaining the first record can comprise a payment network system 130. At least a portion of the information defining the update of the plurality of electronic records can be sent 510 to the system maintaining the first record of the plurality of electronic records.

In response, a message indicating that the update of the plurality of electronic records is authorized pending verification of an identity of a user 105 of the mobile device 110 can be received 515 from the system maintaining the first record. The gaming venue system 120 can then send 520 to the mobile device 110 through the wireless communications interface, a message indicating that the update of the plurality of electronic records is authorized pending verification of an identity of the user 105 of the mobile device 110. According to one embodiment, the message indicating that the update of the plurality of electronic records is authorized pending verification of the identity of the user 105 of the mobile device 110 can comprise instructions for providing verification of the identity of the user 105 of the mobile device 110. For example, the instructions for providing verification of the identity of the user 105 of the mobile device 110 can instruct the user 105 of the mobile device 110 to present an identity credential such as a driver's license at a location within the gaming venue. In another example, the instructions can instruct the user 105 of the mobile device 110 to present an identity credential to a mobile resource of the gaming venue, e.g., a staff person 135 with a mobile terminal 140, dispatched to a location of the user 105 of the mobile device 110. In such cases, providing the instructions can further comprise dispatching the mobile resource to the user's 105 location, e.g., sending an IM or other message to the staff person 135, through the mobile terminal 140 and indicating the location of the user 105 of the mobile device 110 which can be determined in any of a variety of ways as known in the art.

The gaming venue system 120 can receive 525 information verifying the identity of the user 105 of the mobile device 110, e.g., a confirmation message from the terminal 140 of the staff person 135 doing the verification. A message indicating or confirming verification of the identity of the user 105 of the mobile device 10 can then be sent 530 to the system maintaining the first record, e.g., the payment network system 130. In response, the gaming venue system 120 can receive 535 from the system maintaining the first record, a message indicating a final approval of the update of the plurality of electronic records.

According to one embodiment, if the gaming venue system 120 maintains or has access to such records, the gaming venue system 120 can then update 540 a second record of the plurality of electronic records based on the amount of the cash advance, i.e., a record associated with a gaming venue account of the user 105 of the mobile device 110 such as a mobile wallet account. Updating 540 the second record can comprise increasing a value of the second record representing an available game play credit amount based on the amount of the cash advance or other transfer of value. In other cases, such as where the gaming venue system 120 does not maintain or have access to these records, the gaming venue system 120 can request an appropriate system to perform the update to reflect the transfer. In either case, the gaming venue system 120 can then send 545 to the mobile device 110, through the wireless communications interface, a message indicting completion of the cash advance or other transfer and availability of the game play credit amount.

FIG. 6 is a flowchart illustrating an exemplary process for performing an update of records related to a transaction according to yet another embodiment of the present disclosure. More specifically, this example illustrates a process as may be performed by a gaming venue system 120 as described above in response to a user 105 of a mobile device 110 requesting a transfer, e.g., to fund his mobile wallet account from another account such as through a cash advance on a credit card account. As illustrated in this example, performing an update of records related to a transaction can comprise receiving 605, by the gaming venue system 120 through a wireless communications interface, a request from a mobile device 110 to update the plurality of electronic records.

A determination 610 can be made by the gaming venue system 120 that verification of an identity of a user 105 of the mobile device 110 will be needed to complete the update of the plurality of electronic records. Determining 610 that verification of the identity of the user 105 of the mobile device 110 is required to complete the update of the plurality of electronic records can be based on a transaction type associated with the update of the plurality of electronic records, e.g., a credit card cash advance or transfer from another type of account for which the system maintaining that account is known to require such verification.

In response to or based on determining 610 that verification of the identity of the user of the mobile device will be required, the gaming venue system 120 can send 615, to the mobile device 110 through the wireless communications interface, a message indicating that verification of the identity of the user 105 of the mobile device 110 is required to complete the update of the plurality of electronic records and providing instructions for performing the verification of the identity of the user of the mobile device. For example, the instructions for providing verification of the identity of the user 105 of the mobile device 110 can instruct the user 105 of the mobile device 110 to present an identity credential such as a driver's license at a location within the gaming venue. In another example, the instructions can instruct the user 105 of the mobile device 110 to present an identity credential to a mobile resource of the gaming venue, e.g., a staff person 135 with a mobile terminal 140, dispatched to a location of the user 105 of the mobile device 110. In such cases, providing the instructions can further comprise dispatching the mobile resource to the user's 105 location, e.g., sending an IM or other message to the staff person 135, through the mobile terminal 140 and indicating the location of the user 105 of the mobile device 110 which can be determined in any of a variety of ways as known in the art.

Once the identity of the user 105 of the mobile device has been verified, the gaming venue system 120 can receive 620 an indication of the verification and send 625 to the system maintaining a first record of the plurality of records a message requesting the update of the plurality of records and confirming verification of the identity of the user 105 of the mobile device 110. For example, the system maintaining the first record of the plurality of records can comprise a payment network system 130 and the update of the plurality of records can comprise a transaction transferring funds from a first account, e.g., a credit card account of the user 105, associated with the first record to a second account associated with a second record of the plurality of electronic records maintained by the gaming venue system. A value of the second account can define an available game play credit amount for the user of the mobile device, e.g., a mobile wallet balance.

In response, the gaming venue system 120 can receive 630 from the system maintaining the first record of the plurality of records, a message indicating authorization of the update of the plurality of records. If the gaming venue system 120 maintains or has access to such records, the gaming venue system 120 can then update 635 a second record of the plurality of electronic records based on the amount of the cash advance, i.e., a record associated with a gaming venue account of the user 105 of the mobile device 110 such as a mobile wallet account. Updating 635 the second record can comprise increasing a value of the second record representing an available game play credit amount based on the amount of the cash advance or other transfer of value. In other cases, such as where the gaming venue system 120 does not maintain or have access to these records, the gaming venue system 120 can request an appropriate system to perform the update to reflect the transfer. In either case, the gaming venue system 120 can then send to the mobile device 110, through the wireless communications interface, a message indicting completion of the cash advance or other transfer and availability of the game play credit amount.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

1. A mobile device comprising:
a first wireless communications interface;
a processor coupled with the first wireless communications interface; and
a memory coupled with and readable by the processor and storing therein a set of instructions which, when executed by the processor, causes the processor to:
receive an input indicating a request to initiate an update of a plurality of electronic records, the request comprising information defining the update of the plurality of electronic records;
send, through the first wireless communications interface to a gaming venue system, the request to initiate the update of the plurality of electronic records;
receive, from the gaming venue system through the first wireless communications interface, a message indicating authorization of the requested update of the plurality of electronic records pending in-person verification of an identity of a user of the mobile device;
present, through an output device of the mobile device, an indication of the authorization and an indication that the update of the plurality of electronic records is pending in-person verification of the identity of the user of the mobile device; and
based on completion of the in-person verification, receive, from the gaming venue system through the first wireless communications interface, a message indicating completion of the update of the plurality of electronic records.

2. The mobile device of claim 1, wherein the set of instructions further causes the processor to present, through the output device, an indication of instructions to perform the verification of the identity of the user of the mobile device.

3. The mobile device of claim 1, wherein the information defining the update of the plurality of electronic records comprises information identifying an amount of a transfer of funds from a first account of the user of the mobile device associated with a first record of the plurality of electronic records to a second account of the user of the mobile device associated with a second record of the plurality of electronic records.

4. The mobile device of claim 3, wherein the information defining the update of the plurality of electronic records further comprises information defining a payment instrument associated with the first account.

5. The mobile device of claim 4, wherein the payment instrument comprises a credit card and the transfer of funds comprises a cash advance on the credit card.

6. The mobile device of claim 1, wherein the set of instructions further causes the processor to
present, through the output device of the mobile device, an indication of the completion of the update of the plurality of electronic records.

7. The mobile device of claim 1, wherein the mobile device further comprises a second wireless communications interface coupled with the processor and wherein the set of instructions further causes the processor to provide, through the second wireless communications interface to the gaming venue system, information verifying the identity of the user of the mobile device.

8. A system of a gaming venue, the system comprising:
a wireless communications interface;
a processor coupled with the wireless communications interface; and
a memory coupled with and readable by the processor and storing therein a set of instructions which, when executed by the processor, causes the processor to:
receive, from a mobile device through the wireless communications interface, a request to initiate an update of a plurality of electronic records, the request comprising information defining the update of the plurality of electronic records;
send, to a system maintaining a first record of the plurality of electronic records, at least a portion of the information defining the update of the plurality of electronic records;
receive, from the system maintaining the first record, a message indicating that the update of the plurality of electronic records is authorized pending in-person verification of an identity of a user of the mobile device; and
send, to the mobile device through the wireless communications interface, a message indicating that the update of the plurality of electronic records is authorized pending in-person verification of an identity of the user of the mobile device^{.} and
based on receipt of information verifying the identity of the user of the mobile device, send, to the system maintaining the first record, a message indicating verification of the identity of the user of the mobile device.

9. The system of claim 8, wherein the message indicating that the update of the plurality of electronic records is authorized pending in-person verification of the identity of the user of the mobile device further comprises instructions for providing verification of the identity of the user of the mobile device.

10. The system of claim 9, wherein the instructions for providing verification of the identity of the user of the mobile device instruct the user of the mobile device to present an identity credential at a location within the gaming venue.

11. The system of claim 9, wherein the instructions for providing verification of the identity of the user of the mobile device instruct the user of the mobile device to present an identity credential to a mobile resource of the gaming venue dispatched to a location of the user of the mobile device.

12. The system of claim 8, wherein the set of instructions executed by the processor of the system further causes the processor to
receive, from the system maintaining the first record, a message indicating a final approval of the update of the plurality of electronic records.

13. The system of claim 12, wherein the update of the plurality of electronic records comprises a cash advance on a credit card account of the user of the mobile device, wherein the information defining the update of the plurality of electronic records comprises information identifying the credit card account and an amount of the cash advance, wherein the first record of the plurality of electronic records is associated with the credit card account, and wherein the system maintaining the first record comprises a payment network system.

14. The system of claim 13, wherein the set of instructions further cause the processor to:
update a second record of the plurality of electronic records based on the amount of the cash advance, the second record associated with a gaming venue account of the user of the mobile device and wherein updating the second record comprises increasing a value of the second record representing an available game play credit amount based on the amount of the cash advance; and
send, to the mobile device through the wireless communications interface, a message indicting completion of the cash advance and availability of the game play credit amount.

15. A method for performing an update on a plurality of electronic records, the method comprising:
receiving, by a gaming venue system through a wireless communications interface, a request from a mobile device to update the plurality of electronic records;
determining, by the gaming venue system, that in-person verification of an identity of a user of the mobile device is required to complete the update of the plurality of electronic records;
in response to determining that in-person verification of the identity of the user of the mobile device is required, sending, by the gaming venue system to the mobile device through the wireless communications interface, a message indicating that in-person verification of the identity of the user of the mobile device is required to complete the update of the plurality of electronic records and providing instructions for performing the in-person verification of the identity of the user of the mobile device;
receiving, by the gaming venue system, an indication of verification of the identity of the user of the mobile device;
sending, from the gaming venue system to a system maintaining a first record of the plurality of records, a message requesting the update of the plurality of records and confirming verification of the identity of the user of the mobile device; and
receiving, by the gaming venue system from the system maintaining the first record of the plurality of records, a message indicating authorization of the update of the plurality of records.

16. The method of claim 15, wherein determining that in-person verification of the identity of the user of the mobile device is required to complete the update of the plurality of electronic records is based on a transaction type associated with the update of the plurality of electronic records.

17. The method of claim 16, wherein the transaction type comprises a cash advance on a credit card account associated with a first record of the plurality of electronic records.

18. The method of claim 15 wherein the instructions for performing the in-person verification of the identity of the user of the mobile device instruct the user of the mobile device to present an identity credential to a mobile resource of the gaming venue and wherein the method further comprises dispatching, by the gaming venue system, the mobile resource of the gaming venue to a location of the user of the mobile device.

19. The method of claim 15 further comprising sending, from the gaming venue system to the mobile device, a message indicating that the update of the plurality of records has been completed.

20. The method of claim 19, wherein the system maintaining the first record of the plurality of records comprises a system of a payment network, wherein the update of the plurality of records comprises a transaction transferring funds from a first account associated with the first record to a second account associated with a second record of the plurality of electronic records maintained by the gaming venue system, a value of the second account defining an available game play credit amount for the user of the mobile device, and wherein the method further comprises updating the value of the second record based on an amount of the transaction.
